(19) United States
(12) Patent Application Publication
(10) Pub. No.: US 2017/0023109 A1
(43) Pub. Date: Jan. 26, 2017

(54) TRANSMISSION AND COMPONENTS THEREOF

(71) Applicant: MODBOT, INC, SAN FRANCISCO, CA (US)

(72) Inventor: Adam Charles Ellison, Fitzroy North, VIC (AU)

(21) Appl. No.: 15/102,821

(22) PCT Filed: Jan. 7, 2015
(86) PCT No.: PCT/US2015/010528

§ 371 Date: Jun. 8, 2016

Related U.S. Application Data
(60) Provisional application No. 61/924,346, filed on Jan. 7, 2014.

(51) Int. Cl. F16H 13/10; F16H 55/32; F16H 57/08; F16H 13/02; F16H 19/04; F16H 49/00; F16H 13/06

(52) U.S. Cl. CPC F16H 13/10; F16H 49/001; F16H 55/32; F16H 13/06; F16H 13/02; F16H 19/04; F16H 57/08

(57) ABSTRACT

A transmission and components thereof are provided. In one aspect, the transmission component has one or more formations, the one or more formations being substantially elongate and running along an engagement face of the component, the formation(s) configured to be frictionally engagable with a substantially elongate recess of a second transmission component; and/or (ii) one or more recesses, the one or more recesses being substantially elongate and running along an engagement face of the component, the recess(es) configured to be frictionally engagable with a substantially elongate formation of a second transmission component. In a second aspect, the transmission has a first transmission component and a second transmission component having one or more substantially elongate recesses, wherein the formation(s) of the first transmission component are frictionally engageable with the recess(es) of the second transmission component, such that in use the first transmission component is capable of driving the second transmission component. In a third aspect, a method for improving the torque density of a transmission is provided by setting or adjusting an amount of frictional engagement between two components involved in the torque flow through the transmission.

### PRIORITY CLAIM/RELATED APPLICATION

This application claims the benefit of and priority under 35 USC 119(e) and 120 to U.S. Provisional Patent Application Ser. No. 61/924,346, filed on Jan. 7, 2014 and entitled “Transmission and Components Thereof”, the entirety of which is incorporated herein by reference.

### FIELD

The disclosure relates to power transmission devices. More particularly, the disclosure provides traction based mechanical transmissions and transmission components that reduces the pre-load force required to generate traction which improves torque density, and also avoids backlash. Reducing the pre-load force required to create a given traction force improves the effective traction coefficient by a factor of 1.1 to 10 over existing designs. The improvement is only limited in practice by the acceptable spin losses in a given application and the choice of materials and lubricant used.

### BACKGROUND

Power transmission devices are used in many settings, typically for transferring rotational motion from an input shaft rotating at a first speed, to an output shaft at a different speed to the first. For example, speed reduction gearing is used in vehicle transmissions to reduce high revolution engine output to a lower speed suitable for turning the vehicle wheels. As another example, the rotational output of an electric servo motor is typically slowed to make the output more useful.

Mechanical transmissions of the prior art are typically composed of toothed gears, the meshing arrangement of the gears allowing for one gear to drive another. By meshing gears having different radii (and therefore a different numbers of teeth), rotational speed may be increased or decreased relative to the input.

Backlash (also termed “lash” or “play”) is a well known problem in the use of toothed gears. Backlash is the amount by which the width of a gear's tooth space exceeds the thickness of an engaging tooth measured at the pitch circle of the gears. Backlash is a problem for all transmissions relying on toothed gears, however is particularly undesirable is precision positioning applications such as robotics. For example, in servo-mechanical transmissions common in robotic arms, the rotational direction of the servo is required to reverse frequently. Backlash in a servo-mechanical transmission leads to a time delay in reversal of the output shaft given the time required to take up the clearance between gear teeth.

Prior art approaches to the problem of backlash in a transmission have relied on strain wave gearing, cycloidal transmissions and sprung pre-load systems. While partially effective, these prior art solutions introduce further complexity into the transmission, and in any event do not completely remove blacklash.

While undesirable, it is a dogma of mechanical engineering that backlash is necessary to accommodate for manufacturing errors, provide space for lubrication and allow for thermal expansion of components.

Traction-based transmissions do not suffer from backlash, however in these systems a large pre-load is necessary for operation. Maintaining a large pre-load decreases the efficiency of the transmission and can damage the engagement surfaces over time. Furthermore, traction-based transmissions exhibit relatively low torque densities due to the mass and strength of components required to support the large pre-load necessary to transmit torque.

It is a further problem in the art that a suboptimal internal force path in traction based transmissions can lead to significant power loss of the transmission overall. For example, traction based transmissions typically pass the pre-load force required to create traction through a rotating bearing, which creates a parasitic power loss. A shorter force path that does not pass through a rotating bearing will reduce the mass of the components necessary to support a given torque output and torque ratio and reduce parasitic power losses.

### SUMMARY

It is an aspect of the disclosure to overcome or alleviate a problem of the prior art by providing transmissions and transmission components capable of high output torques and large torque ratios that are substantially devoid of backlash and/or provide the ability to improve or optimize the force path in a transmission. It is a further aspect to provide an alternative to prior art transmission components and prior art transmissions.

In a first aspect, the disclosure provides a transmission component comprising: (i) one or more formations, the one or more formations being substantially elongate and running along an engagement face of the component, the formation(s) configured to be frictionally engagable with a substantially elongate recess of a second transmission component; and/or (ii) one or more recesses, the one or more recesses being substantially elongate and running along an engagement face of the component, the recess(es) configured to be frictionally engagable with a substantially elongate formation of a second transmission component.

In one embodiment, where the component is substantially circular, the substantially elongate formation(s) run substantially circumferentially around the component. For example, the component may be circular, a deformed circle in a strain-wave transmission embodiment or a non-circular gear in one embodiment. In one embodiment, the formation(s) is/are substantially tooth-shaped in cross-sectional profile, and may comprise two angled surfaces. In one embodiment, the angled surfaces of two adjacent formations form a recess, the recess configured to be frictionally engagable with a substantially elongate formation of a second transmission component.

In one embodiment, the formation(s) may be substantially wedge-shaped. In one embodiment, the transmission component comprises a plurality of formations and/or recesses. In one embodiment, the formations of the transmission component may form a substantially zig-zag cross-sectional profile.

In one embodiment, the transmission component is configured to be rotatably mountable, and may be configured to be a gear-like component of a transmission, and particularly of an epicyclic transmission or a strain wave transmission. The epicyclic transmission may be a compound epicyclic transmission, with the component configured to be a sun gear-like component, or a planet gear-like component, or an annular gear-like component.

In a second aspect of the disclosure there is provided a transmission comprising: a first transmission component as described herein, and a second transmission component having one or more substantially elongate recesses, wherein the formation(s) of the first transmission component are frictionally engageable with the recess(es) of the second transmission component, such that in use the first transmission component is capable of driving the second transmission component.

In one embodiment, the recess(es) of the second transmission component are substantially a conjugate of or an inverse of the formation(s) of the first transmission component. The recesses also may be complimentary to the formation(s) of the first transmission component.

In one embodiment, the formation(s) and recess(es) are shaped and dimensioned such that in use the transmission is substantially devoid of free play. Specifically, the transmission has immeasurable backlash because the surface of the formation(s) and recess(es) experience Coulomb friction at the interface between the formation(s) and recess(es). As a result, the transmission has almost no free play or backlash.

In one embodiment, the transmission comprises an adjustment mechanism configured to alter the position of the first transmission component relative to the second transmission component. The adjustment mechanism may be configured to adjust the force exerted by the formation(s) of the first transmission component on the recess(es) of the second transmission component. The force may be adjusted in proportion to the torque transmitted by the transmission to optimize losses in the transmission, or it may be altered by some external mechanism.

In one embodiment, the adjustment mechanism comprises a ramped surface, the ramped surface being slidable relative to the transmission component to displace the transmission component laterally.

In one embodiment, the transmission is an epicyclic transmission or a strain wave transmission, and may be a compound epicyclic transmission.

In one embodiment, the transmission is a speed multiplier transmission.

In one embodiment, the transmission is a speed reduction transmission.

In one embodiment, the transmission is in operable combination with a servo motor.

In a third aspect, the disclosure provides method for improving the torque density of a transmission, the method comprising the step of setting or adjusting an amount of frictional engagement between two components involved in the torque flow through the transmission.

In one embodiment, the two components are any two transmission components as described herein.

### BRIEF DESCRIPTION OF THE DRAWINGS

FIGS. 1A and 1B shows two transmission components being frictionally engaged to form a simple transmission wherein FIG. 1A is a perspective view of the two engaged components and FIG. 1B is a cross-sectional view (through the plane B-B) showing more clearly the alternating formations and recesses of the components;

FIGS. 2A and 2B shows a lateral view of the simple transmission of FIG. 1, but in lateral view in FIG. 2A while FIG. 2B shows a cross-sectional view of the transmission to show the area of interaction between the two components;

FIGS. 3A-3D shows diagrammatically and in cross-sectional view a number of alternatives in formation and recess profiles in which the curvatures on engagement surfaces are exaggerated;

FIG. 4A shows a perspective view of a ring gear having formations and recesses on an internal engagement face and a pinion gear having complimentary formation and recesses is frictionally engaged with the ring gear;

FIG. 4B is a cross-sectional view of the arrangement of FIG. 4A, through the plane C-C as defined in FIG. 4C;

FIG. 4C is another view of the arrangement of FIG. 4A;

FIG. 5A shows a perspective view of a transmission having a fixed ratio differential epicyclic configuration;

FIG. 5B is a cross-sectional view of the transmission of FIG. 5A, through the plane D-D as defined in FIG. 5C;

FIG. 5C is another view of the arrangement of FIG. 5A;

FIGS. 6A-6C show, in perspective view, the transmission of FIG. 5, with (i) the addition of an adjustment mechanism for varying the preload between frictionally engaged components, and (ii) reversal of position of the larger and smaller annular gear;

FIG. 7 shows in cross-section view a higher level of detail of the pre-load adjustment mechanism of the transmission shown in FIG. 6;

FIG. 8 shows a topological layout of the transmissions of FIGS. 5 and 6;

FIG. 9A shows a strain wave transmission in perspective view;

FIG. 9B is a cross-sectional view of the transmission of FIG. 9A, through the plane H-H as defined in FIG. 9C;

FIG. 9C is a front view of the transmission of FIG. 9A;

FIG. 9D illustrates further details of the transmission in FIG. 9A;

FIG. 10A shows in cross-sectional view frictionally engaged formation and recess of two transmission components;

FIG. 10B is a vector force diagram of the circled area in FIG. 10A;

FIG. 11 is a rack and pinion transmission having the formations and recesses;

FIGS. 12A and 12B are a perspective view and a top view, respectively, of a bevel transmission having the formations and recesses; and

FIGS. 13A and 13B are a perspective view and a top view, respectively, of a crown and pinion transmission having the formations and recesses.

### DETAILED DESCRIPTION OF ONE OR MORE EMBODIMENTS

After considering this description it will be apparent to one skilled in the art how the invention is implemented in various alternative embodiments and alternative applications. However, although various embodiments of the disclosure will be described herein, it is understood that these embodiments are presented by way of example only, and not limitation. As such, this description of various alternative embodiments should not be construed to limit the scope or breadth of the disclosure. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the disclosure. Thus, appearances of the phrases “in one embodiment” or “in an embodiment” in various places throughout this specification are not necessarily all referring to the same embodiment, but may.

The terms “first”, “second” and other ordinal terms used to describe the transmission components are used only to denote the separate nature of the components. The terms are not to be construed to denote importance, size, timing or any other consideration unless that intention is otherwise clearly stated.

Accordingly in a first aspect, but not necessarily the broadest aspect, the disclosure provides a transmission component comprising: (i) one or more formations, the one or more formations being substantially elongate and running along an engagement face of the component, the formation(s) configured to be frictionally engagable with a substantially elongate recess of a second transmission component; and/or (ii) one or more recesses, the one or more recesses being substantially elongate and running along an engagement face of the component, the recess(es) configured to be frictionally engagable with a substantially elongate formation of a second transmission component.

The disclosure represents a significant departure from the toothed gears of prior art transmissions whereby the meshing arrangement of the teeth effects the transfer of rotational motion from one gear to another. In the disclosure, an elongate formation on the engagement surface of the first component frictionally engages with a recess on the engagement surface of a second component in the transmission such that rotational motion is transferred from the first component to the second component.

By dispensing with the necessity for meshing teeth, it will be appreciated that backlash is completely obviated by use of the present components in a transmission. Rotational motion is immediately transferred between components, and without any lag time whatsoever. This is of clear advantage in servo-mechanical applications particularly, where backlash can dramatically impact on which the speed in which a robot arm, for example, can reverse direction.

Furthermore, in precision positioning applications, there is no need to account for backlash when attempting to determine the position of a part on three-dimensional space.

As used herein, the term “formation” is intended to mean any structure that is capable of frictionally engaging with a recess in a second transmission component.

Where the component is circular, the engagement face is the circumferential face. In that case, the formation(s) encircle the component and extend outwardly and radially to facilitate contact with a recess of an adjacent component. Where the component is rotatably mountable, the longitudinal axes of the formation(s) are typically perpendicular to the rotational axis of the component. The component also may be substantially circular in a strain-wave embodiment (deformed circle) or a non-circular gear embodiment in which the formation(s) encircle the component and extend outwardly and radially to facilitate contact with a recess of an adjacent component.

It will be appreciated that while a component of the disclosure will be typically circular and rotatably mountable (and can therefore be considered as a gear-like component), other arrangements are contemplated. For example, a component of the disclosure may be a rack-like component, whereby the formations run along the longitudinal axis of the rack. Such a rack like component may be configured to frictionally engage with a gear-like component having complimentary recesses, such that rotation of the gear-like component causes a longitudinal displacement of the rack-like component.

The formation(s) of the present components are typically of uniform cross-sectional profile along their length, and may have any profile suitable for the frictional engaging function required. The cross-sectional profile may be finger-shaped, tooth-shaped, arch-shaped, wedge-shaped, triangular, rectangular, trapezoid, or semi-circular for example.

Preferably, the formation(s) comprise two angled surfaces, which may form an apex. The two surfaces (where substantially planar) may be disposed at any angle relative to each other, including at least about 5, 10, 15, 20, 25, 30, 35, 40, 45, 50, 55, 60, 65, 70, 75, 80, or 85 degrees.

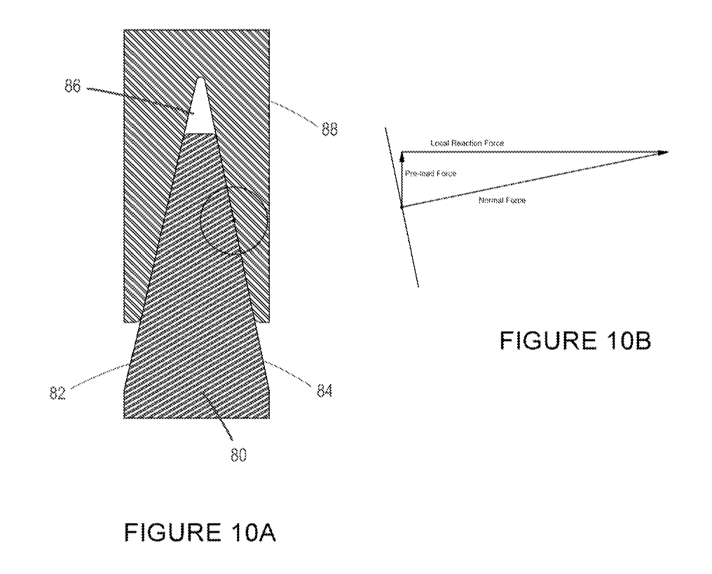

Reference is made to FIG. 10A showing a formation 80 having two angled surfaces 82 and 84, the formation 80 being engaged with the recess 86 of an adjacent component 88. It will be noted from the vector diagram of FIG. 10B that the angle made by the two angled surfaces 82 and 84 determines the proportion of force normal to the face (which is desirable to give traction) to the pre-load force (which is typically undesirable, as it must be passed through the entire transmission system), which provides a resultant local reaction force.

It is preferred to have a contact angle approaching (but not reaching) 90 degrees from the rotation axis. In reality, the manufacturing limitations of making very sharp valleys and peaks prevent this, and therefore a face angle between 45 and 85 degrees from the axis is typically used.

In one embodiment, the formation(s) is/are substantially wedge-shaped. A wedge-shape provides the advantage that the amount of frictional engagement is alterable by the extent to which the formation is inserted into the recess of the second component. Disposing the formation more fully into a recess results in a greater force applied to the recess surface (and vice-versa), thereby increasing frictional engagement between the components. Prior art toothed gears transmit rotational motion in a fixed manner, with tooth of a first gear simply displacing the meshed tooth of a second gear until the gears ceased to be meshed.

A wedge-shaped formation acts as force multiplier in a manner similar to that of a log splitter. By pushing the wedge-shaped formation more fully into a complimentary recess, the broader part of the wedge is urged against the recess wall to increase a lateral force vector against the recess wall, thereby increasing frictional engagement between the two components. Altering the geometry of the wedge (and in particular the wedge gradient) allows for a required relationship between the distance that the wedge is inserted and the increase in frictional engagement to be established. Provided with the benefit of the present specification, the skilled person is able to arrive at a wedge gradient that is suitable for a given application.

The ability to vary the amount of frictional engagement between the present components is a significant advantage of the prior art, and allows for the amount of power transmitted from one component to another to be varied across a continuum. Thus, where a higher level of torque is required to flow through two components, the two components are maintained closely together to ensure that the formation extends more deeply into the recess thereby increasing frictional engagement. Alternatively, where a lower torque flow is needed, the two components are separated somewhat such that frictional engagement is lessened. This allows for balancing of peak torque capacity against parasitic losses such as spin loss and the hysteresis of Hertzian contact stresses.

Another advantage of some embodiments is a reduced spin loss of a transmission comprising the gear-like components. Spin loss is a term given to frictional losses caused by differences in radius within the contact area between two engagement surfaces. Spin loss is a function of the difference in radius between the outer-most contact point, and the inner-most contact point within the contact area. The disclosure reduces the average contact radius difference by using multiple instances of a relatively small formation size, therefore maintaining the advantages of an extended line of contact while minimizing spin losses.

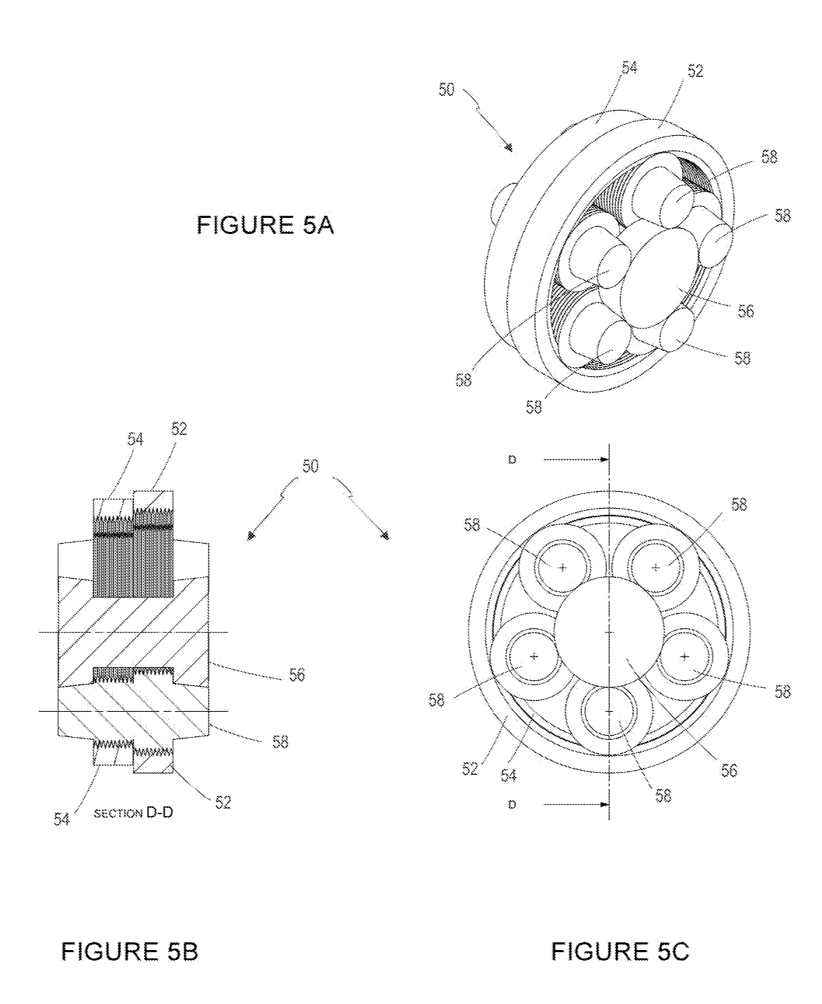

A further advantage of the present gear-like components is their ability to not only transmit torque, but also support radial forces that would normally be supported by external bearings in a transmission. This provides particular advantage in volume or mass constrained arrangements such as robot arm joints. In particular, the force perpendicular to the circumference of the meshing surface (referred to as the pre-load force in this document) can support external loads while still providing sufficient pre-load to transfer torque. For example, in a strain wave or an epicyclic embodiment shown in FIGS. 5, 6 and 9A-9D, the planet like components can support radial and small axial loads between the sun like component and the annulus like components. In the strain wave embodiment, further axial forces can be supported between the strain wave component and the annulus component in some embodiments. In the compound epicyclic embodiment, a variety of forces can be supported between the two annulus components in addition to the forces described above. For an electrically driven application using this transmission, the motor may not require its own bearings (so long as it is approximately central to the mechanism) as the rotor can be integrated into the sun assembly.

The present components may be configured to allow the level of frictional engagement between two components to be altered. For example, where the component is rotatably mounted, the component/mounting combination may be displaceable laterally to increase or decrease the amount of engagement with an adjacent component.

In some embodiments, the component has no associated hardware to facilitate alteration in frictional engagement. For example, where a component is mounted between two other components, (for example where a planet gear-like component is mounted between a sun gear-like component and annular gear-like component in an epicyclic arrangement) then the planet gear-like component may be firmly compressed between the annular gear-like component and the sun gear-like component. Hollow components (such as the planet components of an epicyclic transmission) may be utilized as a spring to apply a pre-load force evenly between the components. In such embodiments the hollow component may be configured to be resiliently deformable and therefore slightly deflect out of round. The diameters of any of the gear-like components (sun, planet or annular) may be configured to increase or decrease the level of frictional engagement between the gear-like components. The hollow components also allow assembly of otherwise interfering designs, for example in an epicyclic arrangement. The hollow components can be temporarily deformed enough to clear the peaks of the meshing formations and then released to provide the required pre-load force in the mechanism.

Each component may have one formation. As will be clear from the foregoing, the components are also capable of engaging via multiple formation/recess interactions. Thus, each component in such embodiments has at least 2, 3, 4, 5, 6, 7, 8, 9, 10, 11, 12, 13, 14, 15, 16, 17, 18, 19 or a plurality of formations, and typically a substantially equal number of recesses. For example, a first component may have 10 formations and 10 recesses; and a second component have 10 formations (each capable of engagement with the recesses of the first component) and 10 recesses (each capable of engagement with the formations of the first component). Each component also may have up to 100 formations and 100 recesses.

Provided with the benefit of the present specification, for any given formation the skilled person is enabled to arrive at a recess that is capable of frictional engagement with that formation. For example, where the formation is wedge-shaped, the recess may be V-shaped. It is not necessary (and in some cases it is undesirable) that the recess is a substantial conjugate or inverse of the formation. For example, the recess may be deeper than the formation is high, or narrower than the formation is wide such that the formation can never fully seat into the recess (assuming of course a usable rigidity of the components).

In one embodiment of the component, where the formations are wedge-shaped, the angled surfaces of two adjacent formations form a recess, the recess configured to be frictionally engagable with a substantially elongate formation of a second transmission component. Thus, the surfaces of the formation are configured to define both the formation and a recess, thereby allowing for the first component to engage with the recess of a second component, and the formation of the second component engage with the recess of the first component.

The apex where the two angled surfaces of the formation join to form the wedge may not be pointed, and may be rounded or even squared off. Similarly, where a recess is formed by the joining of two angled surfaces of adjacent formations, the bottom may rounded or squared off.

In one embodiment, the formations form a substantially zig-zag cross-sectional profile, with the angled surfaces forming alternate formations and recesses in series. This embodiment allows for virtually all the circumferential surface of the component to participate in frictional engagement, thereby optimizing power transmission for the size of the component.

While the engagement face may be completely dedicated to the provision of formation(s) and/or recess(es) (such as in the zig-zag arrangement described supra), in some embodiments there are region(s) disposed between formation(s) and recess(es) which are not involved in frictional engagement.

Advantageously, the use of a zig-zag shaped friction engagement surface yields an extended line of contact between two gear-like components, which, when combined with a given normal force, determines the possible shear force transmittable, and therefore the torque that can be transmitted by a given ‘gear’ radius and width.

In one embodiment, the formation(s) is/are substantially continuous and, where the component is circular, may extend endlessly around the circumference of the component.

The components may be considered to be substitutions for regular toothed gears, and therefore configured to be a gear-like component of a transmission. They are typically rotatably mountable, but may be fixed (for example where formations and recesses are provided on the inner circumferential surface of an annular gear of an epicyclic transmission). The components also may be configured to be operable within the context of an epicyclic transmission (or even a compound epicyclic transmission), and configured as a sun, planet or annular gear-like component.

The present components may be fabricated from a material deemed suitable by a skilled person having the benefit of the present specification. Of course, the material must have sufficient frictional properties to cause the transmission of rotational motion between components taking into account the amount of force exerted by the formations on the recesses. Thus, where the components have lower frictional properties, the amount of force placed on the recess by the formation will be higher, as compared with components having higher frictional properties. A further consideration is that the material requires a minimum rigidity in order to resist the high forces involved in the formation/recess interaction. Materials that are not sufficiently rigid will deform, thereby not allowing for the development of the required frictional engagement between components. It is also desirable that the material have some resistance to cyclic stresses and fatigue. Common bearing steels such as AISI/SAE 52100 and 440C Stainless Steel have this property.

The present gear-like components may be manufactured from substantially the same materials as for prior art toothed gears. However, due to the lack of impact stresses inherent in toothed gear systems, the present components may also be fabricated from ceramics such as silicon nitride and zirconium nitride.

An advantage of the present gear-like components is that the circumferential formations and recesses can be turned in a lathe or roll-formed, in contrast to prior art toothed gears which are hobbed, scraped or milled. Accordingly, the present components may be manufactured more cost-effectively and in shorter time than prior art gears.

The formations and recesses may be at the macro scale, and therefore capable of being reliably fabricated with conventional tools. At the macro scale, the formations and recesses may have a height or depth of at least about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm or more). At the macro scale the present components may be cast, sintered, roll-formed, ground, forged or produced by CNC or manual machining techniques well known to the skilled person. It is further contemplated that where the formations and recesses are dimensioned at the lower end macro scale, or at the micro-scale (i.e. down to around 100 nm), chemical etching, roll-forming, laser etching and electrode-discharge machining (EDM) techniques can be utilized.

Implementation of formations and recesses at the nano scale may be practical for very small rolling elements or very precise arrangements that are designed to operate without lubrication. At the nano scale potential manufacturing techniques include focused ion beam machining, nanoimprint lithography, optical lithography, X-ray lithography, dip pen nanolithography, electron beam lithography, atomic layer deposition, molecular vapor deposition, and molecular self-assembly techniques.

It will be appreciated that the present transmission components may be used in a range of transmission types, from simple to more complex. The skilled person is enabled, given the benefit of the present specification to assess the suitability of the present components and replacement for prior-art toothed components in any existing transmission type.

In a second aspect the disclosure provides a transmission comprising a first transmission component as described herein, and a second transmission component as described herein having one or more substantially elongate recesses, wherein the formation(s) of the first transmission component are frictionally engageable with the recess(es) of the second transmission component, such that in use the first transmission component is capable of driving the second transmission component.

Any of the features recited in respect of the transmission components supra are intended to be selectable as a component of the present transmissions. These features are incorporated herein by reference only for the purpose of brevity and clarity, and so not as to obscure the main inventive concepts.

As used herein, the term “transmission” is intended to be construed broadly to mean only the minimal components required to transfer rotational motion from an input to an output. Although a transmission of the disclosure may have any one of more of the following components, these components are not essential features of the disclosure: a clutch, a housing or casing, a mounting, an input shaft, an output shaft, a torque convertor, a lubricant, a valve, a solenoid, a flywheel, a turbine, or a governor.

Any transmission must have at least two of the present components, with the first component comprising at least one formation (and optionally at least one recess) and the second component comprising at least one recess (and optionally at least one formation).

To ensure sufficient frictional engagement in some embodiments, the recess may be a conjugate or inverse of the formation or complimentary to the formation for which it is intended to engage. For example where the formation is wedge-shaped, the recess may have walls disposed at an angle the same or similar to the walls of the wedge to facilitate engagement.

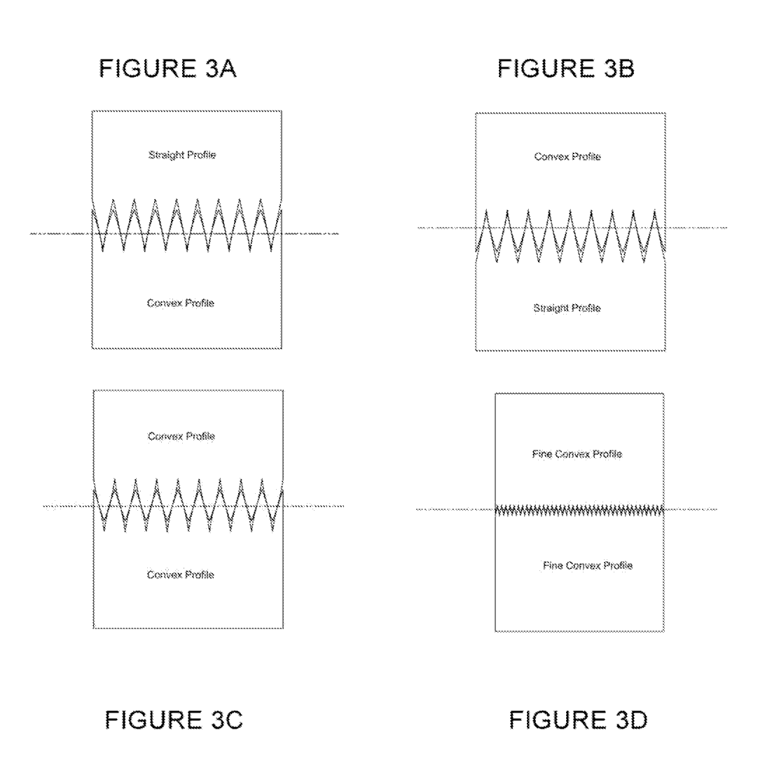

It will be appreciated, however, that formations and profiles having a non-minor image relationship are nevertheless useful. FIG. 3 shows that various profile combinations may be useful in various applications. For example, formations having a convex profile may frictionally engage with recesses having a straight profile (see FIG. 3A; curvatures exaggerated to more clearly show the arrangement). This limits the contact surface area given that the tip of the formation is unable to frictionally engage with recess walls, and may be useful when the transmission is under relatively light loads, hence improving efficiency. When the transmission is loaded, the contact area enlarges as the steel is deformed slightly.

Preferably, the formation(s) and recess(es) are shaped and dimensioned such that in use there is substantially no free play between the components.

In one embodiment, the transmission is an epicyclic transmission. The use of frictionally-engaging gear-like components is particularly advantageous in epicyclic transmissions given the multiple gearing components through which power may flow through the device, and the ability to improve or optimize the force path using variable frictional engagement of the gear-like components.

A particular type of epicyclic transmission comprises two annular gears of differing diameter. The larger or smaller diameter annuls may be used for the high-torque output while the other provides reaction torque.

In one embodiment, the transmission comprises an adjustment mechanism configured to alter the position of the first transmission component relative to the second transmission component. This allows for the setting of preload, and therefore an alteration of the amount of frictional engagement between the two components, as discussed supra.

Given the benefit of the present specification, the skilled person will be enabled to devise a range of adjustment mechanism that may be used. For example, the mounting of one component may be disposed on a track allowing the component to travel along the track while remaining rotatably mounted. The mounting may be locked (reversibly, semi-permanently or permanently) in a desired position along the track to provide for a fixed level of frictional engagement advantageous for a given application.

In one embodiment, the adjustment mechanism is configured to dynamically apply a pre-load based on the torque in the system. Such mechanisms are known to the skilled artisan. Dynamic pre-load mechanisms are contemplated to be useful in larger systems where the primary function of a transmission is to transmit power efficiently with a varying load, as required in an automotive transmission or a wind turbine transmission for example.

While not essential, but to improve longevity and/or torque, the present transmissions may be lubricated with a traction fluid which provides a high shear resistance when pressurized at the point of contact, allowing a thin film of lubricant to transmit torque. The fluid may also provide lubrication for the other transmission components. Where a liquid lubricant is used, a splash, mist, or pressurized delivery system may be implemented.

Non-liquid (grease-like) lubricants may also be operable, thereby negating the need for a delivery system. Use of advanced materials and surface treatments such as engineering ceramics or metallic coatings to fabricate components may allow the present transmission to operate efficiently without any lubrication whatsoever.

In addition to the above embodiments in which lubricants may be used with the transmission, the transmission and components thereof may be operated without a traditional liquid lubricant to protect surfaces from wear due to the much reduced surface sliding compared to typical toothed gears. Thus, the transmission and components thereof may use coatings like gold on a chrome steel or stainless steel substrate in which the coatings have been shown to reduce surface damage from sliding friction by a factor of up to 130 compared to an untreated surface (as shown for example in http://www.dtic.mil/dtic/tr/fulltext/u2/653974.pdf that is incorporated herein by reference). Alternatively, the transmission and components thereof may use special purpose lubricants that maintain some shear strength under pressure. One example of such a traction fluid is Idemitsu's TDF (Traction Drive Fluid) which is described in more detail at http://www.idemitsu.com/products/lubricants/tdf/ and incorporated herein by reference.

Given the benefit of the present specification, the skilled person is enabled to design a transmission system according to the disclosure. Advantageously, given the lack of teeth, any design is not constrained by the usual requirement for the pitch-circle-diameter to be an integer multiple (as for toothed gears). Accordingly, many more possible ratios can be created.

In order to calculate gearing ratios, the effective radius of a gear-like component is taken as the shortest distance between the rotation axis and the mean (or average) contact point. For symmetrical formations this will be the point half way between the outer-most contact radius and the inner-most contact radius. It will be appreciated that calculating an exact gear ratio based on two radii may not be possible, given the possibility of minor slippage under load.

It is worth noting that traction based designs do not necessarily provide an exact gear ratio based on these radii. The difference is due to slippage under load. It would be common to expect up to 2% slippage.

In another aspect, the disclosure provides a method for improving the torque density of a transmission, the method comprising the step of setting or adjusting an amount of frictional engagement between two components of the transmission.

As will be appreciated, the amount of frictional engagement between two components may be devised on a theoretical and/or empirical basis, and set at manufacture. For example, the rotational axes of two gear-like components may be set with a fixed, predetermined distance there between to provide for a predetermined level of frictional engagement between the two. Alternatively, the distance between rotational axes may be variable, by an adjustment mechanism. Adjustment will allow for an empirical means for determining preferred levels of frictional engagement between components with an aim to improve transmission torque path, and ultimately leading to an improved output parameter (such as torque, or rpm) or an overall transmission parameter (such as power loss, or efficiency).

The transmissions and the components thereof subject the present methods may have any of the features recited supra. These features are incorporated herein by reference only for the purpose of brevity and clarity, and so not as to obscure the main inventive concepts.

The disclosure further provides a transmission component as described herein by reference to any of the accompanying drawings.

The disclosure yet further provides a transmission as described herein by reference to any of the accompanying drawings.

While the disclosure is described mainly by reference to epicyclic and strain wave transmissions, it will be understood that the gear-like components described herein will be useful in other types of transmission. Given the benefit of the present specification, the skilled person is capable of replacing nearly any toothed gear mesh of any transmission with a component of the disclosure.

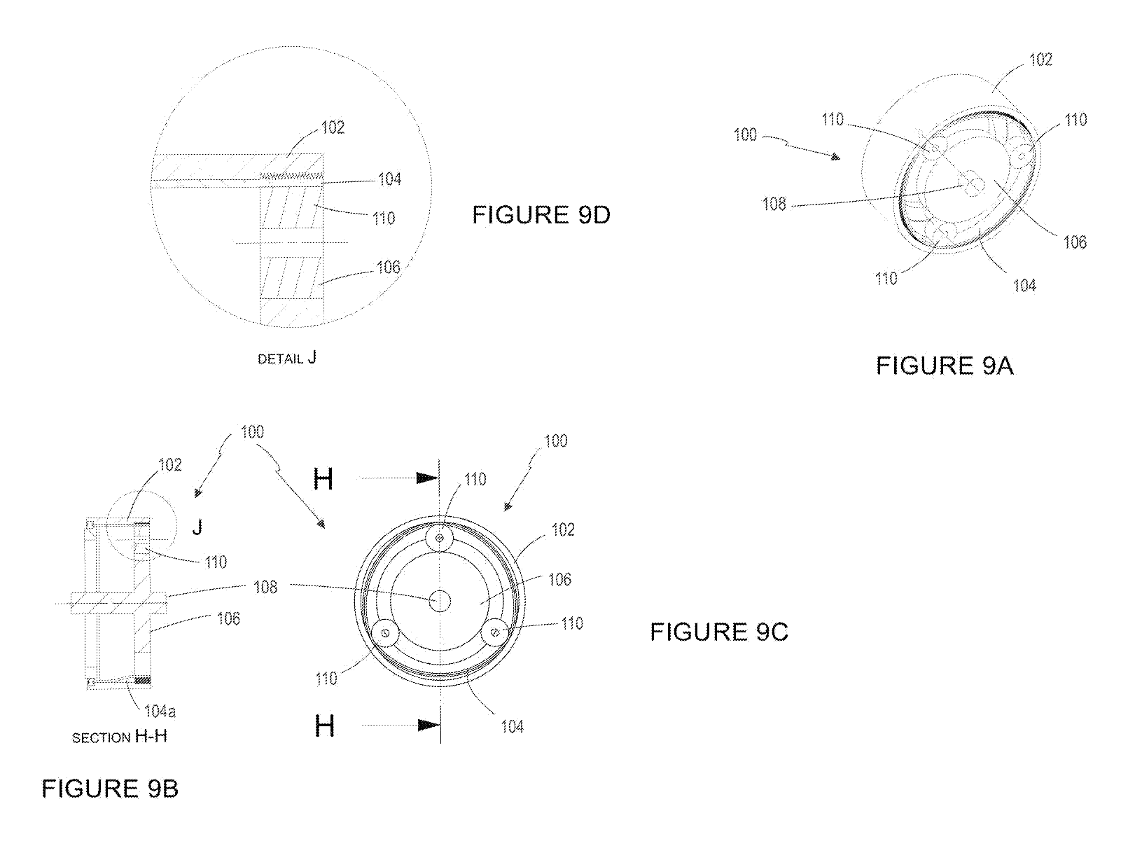

For example, a strain wave transmission may be adapted by replacing the teeth of the circular spline and the flex spline with formations and recesses which frictionally engage. In such embodiments, a point on the engagement surface may flex in and out of contact with another engagement surface. The strain wave transmission may have 1, 2, 3, 4, 5, 6, 7, 8, 9, 10 or more planet rollers. Where the planet rollers are driven by a sun roller as depicted in FIGS. 9A-9D, the overall ratio of the transmission can be altered by a further ratio multiplier of between 2:1 and 9:1. This allows the strain wave design to achieve very high torque ratios or multiplier ratios in a compact form factor. Practical transmission ratios can be achieved between 9:1 and 2000:1 or higher. The strain wave embodiment can also be driven by a non-circular rolling element bearing, known in the art as a wave generator. The said wave generator bearing inner race can be elliptical, eccentric, obround, trochoidal, cycloidal or otherwise similarly shaped to force the formation of the flex-spline like component against the formation of the annulus at 1, 2, 3, 4, 5, 6, 7, 9, 10 or more points spaced around the annulus. The outer race of the wave generator bearing is typically a separate radially flexible component fitting inside the flex spline like component to drive the engagement point around the annulus.

The disclosure may also be amenable to a bevelled gear, a crown and pinion-like system, a rack and pinion-like system, or an eccentric system.

It should be appreciated that in the description of exemplary embodiments of the invention herein, various features of the invention are sometimes grouped together in a single embodiment, figure, or description thereof, for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the various embodiments of the disclosure, those skilled in the art will recognize that other and further modifications may be made thereto without departing from the spirit of the disclosure, and it is intended to claim all such changes and modifications as falling within the scope of the disclosure. Now, the disclosure will be more fully described by reference to the following non-limiting exemplary embodiments.

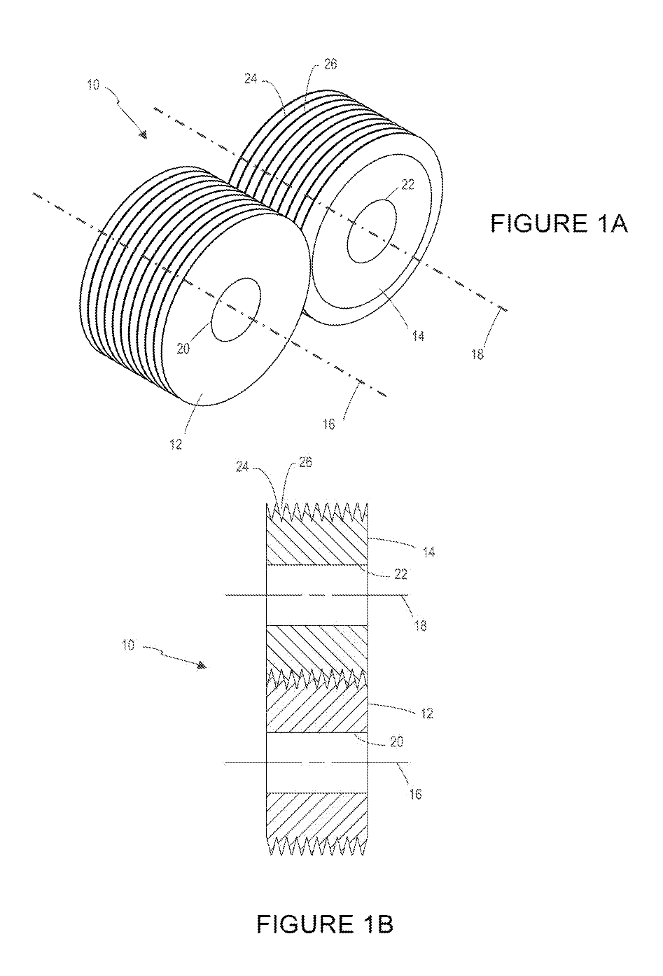

Reference is made to FIG. 1A showing a simple transmission 10 comprising two transmission components 12 and 14 being mutually frictionally engaged by way of alternating wedge-shaped formations 24 and recesses 26 in each component 12, 14.

In this example, the components 12 and 14 are of equal radius, and thus no mechanical advantage is gained. However, the transmission may also have components of different radii so that a mechanical advantage is gained. The transmission components comprise shaft mounts (20 and 22, the shafts not shown) defining axes of rotation 16 and 18.

The alternating wedge-shaped formations 24 and recesses 26 are more clearly shown in the cross-sectional view of FIG. 1B. The zig-zag profile defines series of alternating formations and recesses on a single engagement surface. Both components 12 and 14 have (when compared to each other) substantially identically shaped and dimensioned formations, and also substantially identically shaped and dimensioned recesses. The recesses are conjugates of, inverses of or complementary to the formations, such that the formations are capable of insertion into the recesses, with the angled surfaces of the formations being configured to contact the angled walls of the recesses. In addition to the configuration shown in FIGS. 1A-1B, the formations 24 may be on the first component 12 and the recesses 26 may be on the second component 14 or vice versa. In operation, the formations 24 and recesses 26 may frictionally engage each other to transmit torque between the first and second components. In addition, since the formations and recesses frictionally engage each other, the transmission does not have any backlash.

The numbering of components in the remaining figures is generally consistent with the numbering of FIG. 1.

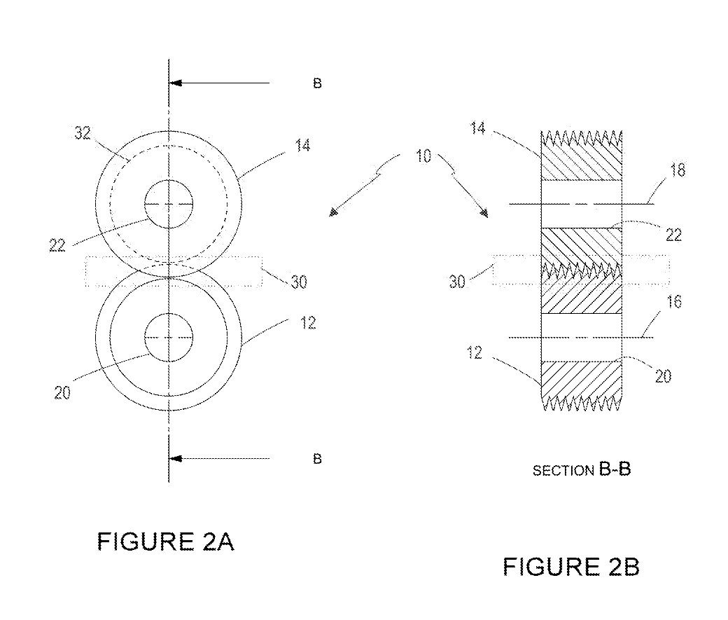

FIG. 2A shows a diagrammatic lateral view of the transmission 10 of FIG. 1. The components 12 and 14 operate to transfer torque between the components like the toothed gears of prior art transmissions, and can be considered to have the equivalent of a root circle 32. The area of frictional engagement 30 of the components 12, 14 is of particular interest, being responsible for the transmission of rotational motion from one component to another. In this embodiment, the formations are wedge-shaped and the recesses being substantial complimentary of the wedge shape. The entirety of the circumferential engagement face is dedicated to defining formation surface and recess wall, there being no region of the engagement face which is not capable of involvement in frictional engagement, this being clear by reference area 30 as shown in FIG. 2B.

FIG. 3 shows diagrammatically a number of other preferred formation and recess combinations operable in the context of the disclosure. In FIG. 3A, the formations and recesses of the upper component has a straight profile, with the angled surfaces of the formations being strictly planar. The lower component in FIG. 3A has formations with a convex profile, with the angled surfaces of the formations being slightly outwardly bowed. FIG. 3B shows the reverse of that situation with upper component having formations with a convex profile and the lower component having formations with straight profiles. FIG. 3C shows both components having formations of convex profile, while FIG. 3D shows very fine convex profiles on both the upper component and lower component.

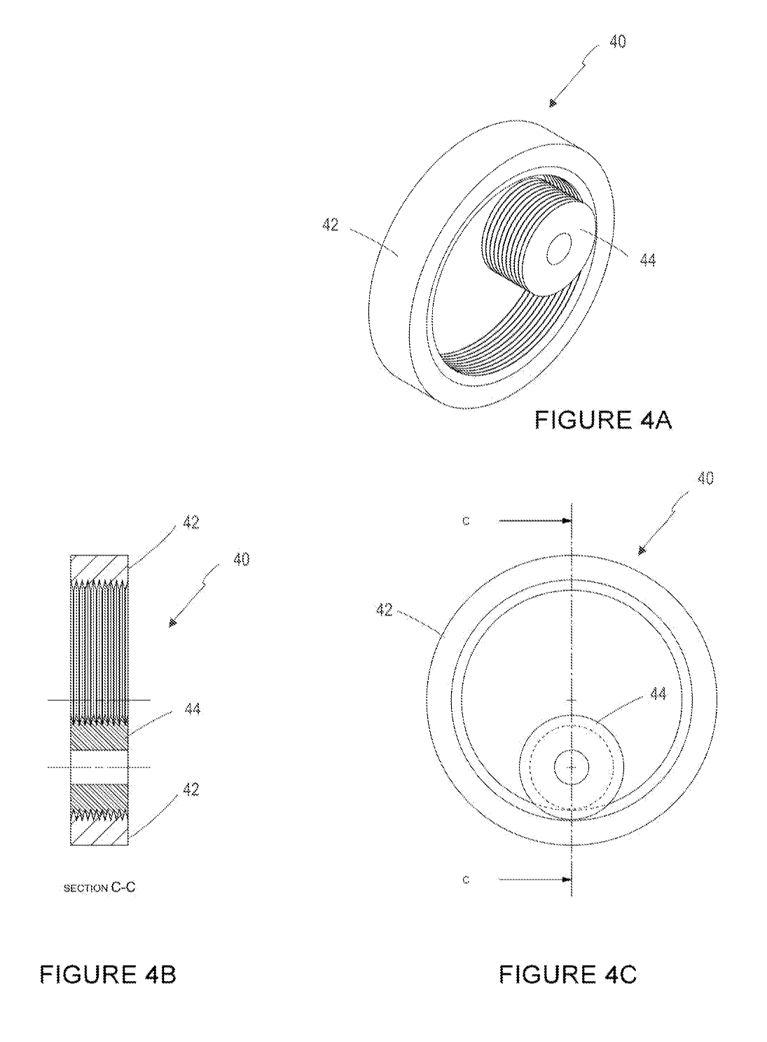

An alternative transmission 40 is shown in FIGS. 4A-4C having a ring gear-like component 42, and a pinion gear-like component 44. The internal surface of the ring component has a series of elongate formations and recesses running around the internal circumference. The external circumference of the pinion component has formations and recesses complimentary to those of the ring component. Upon rotation of the ring component, the frictional engagement causes rotation of the pinion, or vice versa. FIG. 4C shows the area of frictional engagement of the alternate transmission as a dotted line.

FIGS. 5A-5C show a complex epicyclic transmission 50 utilizing the present components, and having a fixed ratio differential. The transmission 50 has an annular gear-like component comprising a greater internal diameter portion 52 and a lesser internal diameter portion 54, a sun gear-like component 56, and 5× planet gear-like components 58. Each of the planet components 58 has a greater and lesser diameter portion adapted to be accommodated within the greater and lesser internal diameter portions of the annular portion 52, 54. Similarly, the sun components 56 has a greater and lesser diameter portion adapted to accommodate the greater and lesser diameters of the planet components 58.

The annular component 52, 54 has formations and recesses on its internal surface configured to frictionally engage with complimentary formations and recesses on the external engagement faces of the planet components 58. The external engagement face of the sun component 56 has formations and recesses complimentary to those of the planet gears.

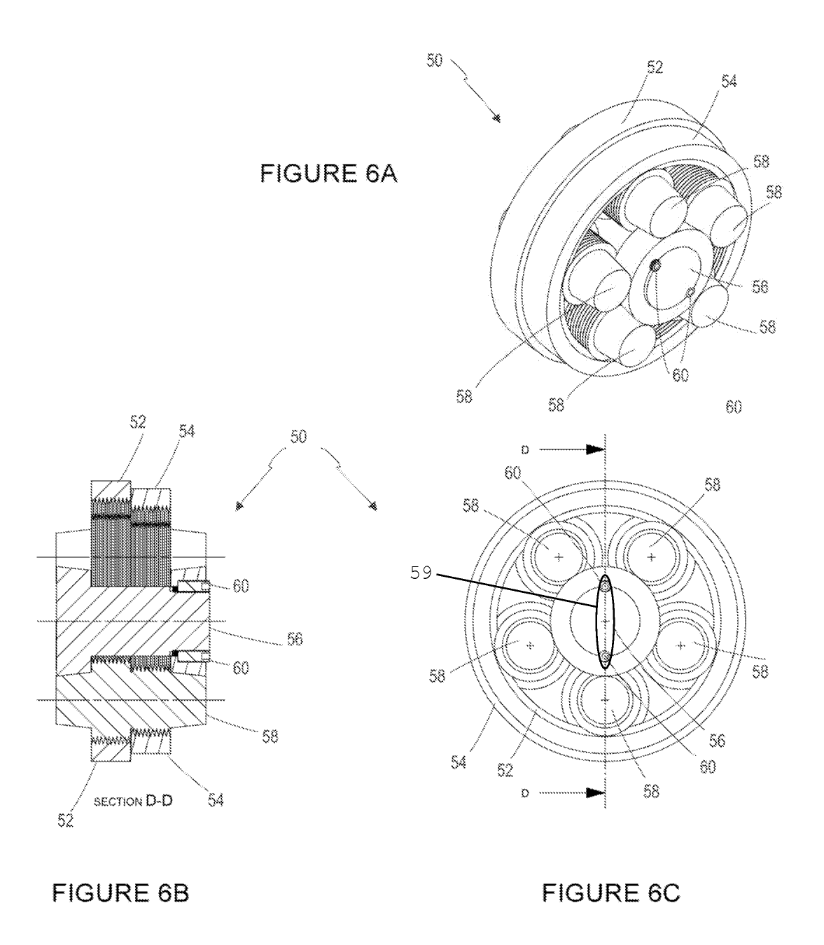

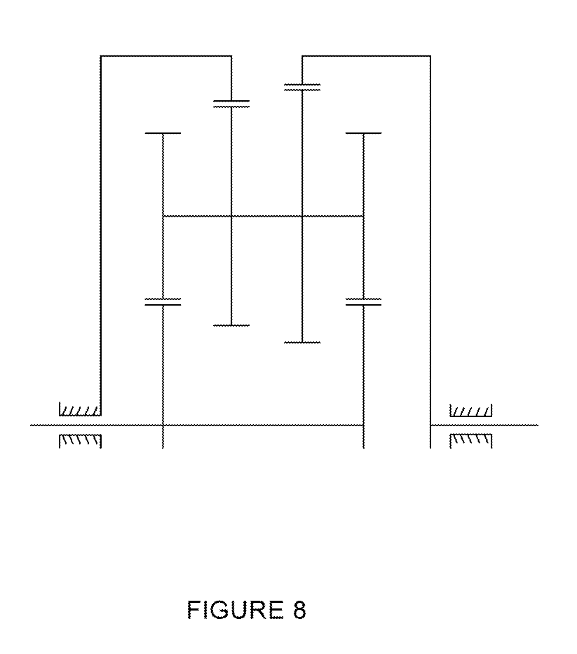

The planetary transmission of FIGS. 6A-6C comprises an adjustment mechanism 59 allowing for pre-load to be placed on the engagement faces of the sun gear and the planet gears. An example of the adjustment mechanism may be a set of grub screws 60 that may be turned inwardly to increase pre-load and outwardly to reduce preload as required. Increasing the pre-load (and therefore the amount of frictional engagement between the sun and planet gears when the transmission is in operation) improves the torque density of the transmission. This provides for the ability to tune the performance of the transmission and compensate for wear, having particular regard to the topological layout as shown in FIG. 8. The adjustment mechanism 59 may also be used in the other examples of the transmissions described herein.

The embodiment in FIG. 6A-6C made be fabricated as a transmission for a small-scale robot arm, and configured to be driven by a servo motor. The wedge-shaped formations of the transmission had a height of 0.2 mm.

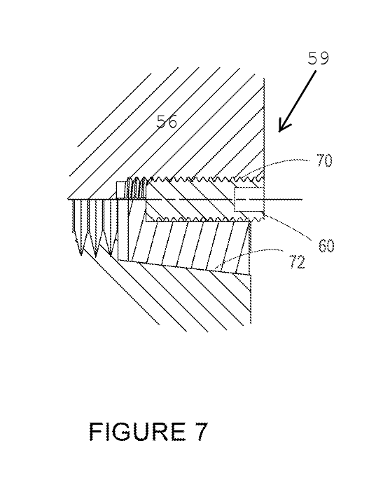

FIG. 7 shows the pre-load adjustment mechanism 59 and in particular the grub screws 60 in greater detail. The grub screw 60 fits into a hole between the centre shaft and the sun component 56. Only a centre side of the hole 70 is threaded, while the outer side 72 is a blind hole with an interference fit. When the grub screw 60 is tightened, it urges the two sun components toward each other while simultaneously acting as a keyway, preventing rotation of one component in relation to the other.

With reference to the embodiments of FIGS. 5 and 6, it is understood that further components such as a planet carrier assembly, rolling element cage, input and output shafts, seals and a housing will typically be required to provide a workable transmission. The skilled person is enabled to provide such additional components by routine methods only.

The disclosure is also as adaptable to a strain wave transmission (also known as a harmonic drive system), as shown in FIG. 9. The transmission of FIGS. 5, 6 and 9 has been shown to be especially useful in servo-mechanical applications given the lack of backlash and useful torque output.

FIGS. 9A-9D show a strain wave transmission embodiment 100, shown in perspective view at FIG. 9A. The transmission comprises a fixed circular spline-like component 102, having formations and recesses encircling an inner engagement surface. Interior to the circular spline 102 is a flex spline-like component 104. The flex spline-like component 104 has formations and recesses encircling an outer engagement surface, and is operably connected to an output shaft (not shown). The formations and recesses of the flex spline-like component 104 and circular spline-like component 102 are complimentary and frictionally engage. Interior to the flex spline-like component 104 is a wave generator comprising a central hub 106 (operably connected to an input shaft 108) and three rollers 110 disposed equidistant about the hub 106. Each roller 100 contacts the interior surface of the flex spline-like component 104, and the exterior surface of the hub 106. Upon rotational input to the transmission, the hub 106 rotates causing the rollers 100 to counter-rotate thereby orbiting in a planetary manner about the hub. The orbiting rollers 110 cause deformation of the flex spline-like component 104, to provide the strain wave.

A cross-sectional view of the transmission 100 is shown in FIG. 9B, the section taken through the plane H-H as shown in FIG. 9C. Detail of the circled region of FIG. 9B is shown in FIG. 9D which more clearly shows the outer engagement face of the flex spline-like component 104 being urged against the inner engagement face of the fixed spline-like component 102 by the roller 110.

Referring back now to FIG. 9B at the lowermost region of the transmission it will be noted that the flex spline-like component 104 is bowed inwardly at the region 104a. This is the configuration of the flex spline-like component 104 when not urged against the inner engagement surface of the fixed spline-like component 102 by a roller 110. As for prior art strain wave transmissions, the flex spline-like component is fabricated using a flexible material. It is contemplated that any material used in prior art transmissions will be applicable to the present strain wave transmission.

As a variation of this preferred embodiment, the wave generator hub may be circular, using the rotating planets to form the wave (as depicted and described supra), or may be configured to contain the wave in its profile with the rollers simply transmitting the change in shape to the flex spline-like component, as per the operation of strain wave transmissions of the prior art having toothed splines.

Advantages of strain wave embodiments include simplicity and ease of manufacturing, along with a higher torque ratio via the sun/planet relationship.

Alternative Configurations for Transmission

In addition to the examples of the transmission set forth above, the transmission and its components may have other configurations. For example, the transmission may have a harmonic gear/strain wave configuration (with one example shown in FIGS. 9A-9D above), a bevel configuration, a rack and pinion configuration and a crown and pinion configuration.

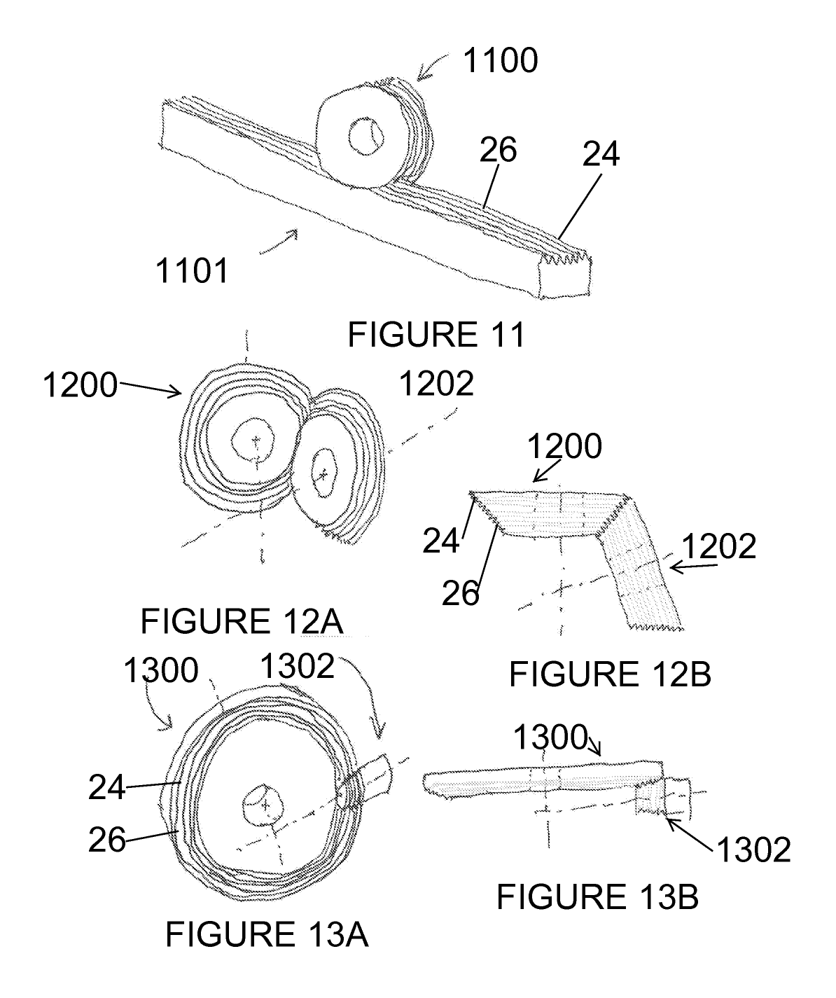

FIG. 11 is a rack and pinion-like transmission having the formations and recesses in which the transmission has a rack component 1101 and a pinion component 1100. The rack and pinion-like configuration (gears and traction wheels) may be used to transform rotary motion into linear motion and vice versa. The rack and pinion-like configuration are commonly used in vehicle steering mechanisms and Cartesian motion control mechanisms. As shown in FIG. 11, the rack and pinion 1100, 1001 may each have one or more formations 24 and one or more recesses 26 that cooperate as already described above.

FIGS. 12A and 12B are a perspective view and a top view, respectively, of a bevel-like transmission having the formations and recesses that has a first component 1200 and a second component 1202. In the bevel-like configuration, an axis of the two shafts (as shown by the dotted lines in FIGS. 12A and 12B) intersect at an angle, typically between 1 degree and 90 degrees, with a meshing surface between two components/wheels 1200, 1202 that allows the transfer of torque. The two components/wheels may be the same size, to allow a redirection of torque bearing shaft, or they may be different sizes to allow a reduction or increase in torque as well as the change in direction. As shown, each of the components may have one or more formations 24 and one or more recesses that cooperate as already described above.

FIGS. 13A and 13B are a perspective view and a top view, respectively, of a crown and pinion-like transmission having the formations and recesses. This transmission may have a crown component 1300 and a pinion component 1302 that interact with each other using the one or more formations 24 and the one or more recesses 26 as shown. In this transmission, the axis of the two components (shown by the dotted lines in FIGS. 13A and 13B) may be nearly 90 degrees, with a meshing surface between two components/wheels 1300, 1302 that allows the transfer of torque.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A transmission component, comprising:
a component having an engagement face;
one or more formations wherein each formation is substantially elongate, the one or more formations running along the engagement face of the component, the one or more formations configured to be frictionally engagable with a substantially elongate recess of a second transmission component; or
one or more recesses wherein each recess is substantially elongate, the one or more recesses running along the engagement face of the component, the one or more recesses configured to be frictionally engagable with a substantially elongate formation of a second transmission component.

2. The transmission component of claim 1, wherein the component is circular and the one or more formations run substantially circumferentially around the component.

3. The transmission component of claim 1 or 2, wherein at least one of the one or more formations is substantially tooth-shaped in cross-sectional profile.

4. The transmission component of any one of claims 1 to 3, wherein at least one formation of the one or more formations has two angled surfaces.

5. The transmission component of claim 4, wherein the angled surfaces of two adjacent formations form a recess, the recess configured to be frictionally engagable with a substantially elongate formation of a second transmission component.

6. The transmission component of any one of claims 1 to 5, wherein the at least one of the one or more formations is substantially wedge-shaped.

7. The transmission component of any one of claims 1 to 6 comprising a plurality of formations and a plurality of recesses.

8. The transmission component of any one of claims 1 to 7, wherein the one or more formations form a substantially zig-zag cross-sectional profile.

9. The transmission component of any one of claims 1 to 8 which is configured to be rotatably mountable.

10. The transmission component of any one of claims 1 to 9 which is configured to be a gear-like component of a transmission.

11. The transmission component of any one of claims 1 to 9 which is configured to be a gear-like component of one of an epicyclic transmission and a strain wave transmission.

12. The transmission component of claim 11, wherein the epicyclic transmission is a compound epicyclic transmission.

13. The transmission component of claim 11 or claim 12 which is configured to be a sun gear-like component, or a planet gear-like component, or an annular gear-like component.

14. A transmission, comprising:
a first transmission component according to any one of claims 1 to 13 wherein the first transmission component have one or more elongate formations;
a second transmission component having one or more substantially elongate recesses; and
wherein the one or more formation of the first transmission component are frictionally engageable with the one or more recesses of the second transmission component, such that in use the first transmission component is capable of driving the second transmission component.

15. The transmission of claim 14, wherein the one or more recesses of the second transmission component are substantially complimentary of the one or more formations of the first transmission component.

16. The transmission of claim 14 or claim 15, wherein the one or more formations and the one or more recesses are shaped and dimensioned such that in use the transmission is substantially devoid of free play.

17. The transmission of any one of claims 14 to 16 further comprising an adjustment mechanism configured to alter the position of the first transmission component relative to the second transmission component.

18. The transmission of claim 17, wherein the adjustment mechanism is configured to adjust the force exerted by the one or more formations of the first transmission component on the one or more recesses of the second transmission component.

19. The transmission of any claim 17 or claim 18, wherein the adjustment mechanism comprises a ramped surface, the ramped surface being slidable relative to the transmission component to displace the first transmission component laterally.

20. The transmission of any one of claims 14 to 19, wherein the transmission is one of an epicyclic transmission and a strain wave transmission.

21. The transmission of claim 20, wherein the epicyclic transmission is a compound epicyclic transmission.

22. The transmission of any one of claims 14 to 21, wherein the transmission is a speed reduction transmission.

23. The transmission of any one of claims 14 to 22 in operable combination with a servo motor.

24. A method for improving the torque density of a transmission, the method comprising:
providing a first transmission component having one or more elongate formations and a second transmission component having one or more elongate recesses;
frictionally engaging the one or more formation of the first transmission component and the one or more recesses of the second transmission component; and
setting the amount of frictional engagement between two components of the transmission to improve the torque density of the transmission.

25. The method of claim 24, wherein the two transmission components are any two components of any one of claims 1 to 13.

26. The method of claim 24 or claim 25, wherein the transmission is the transmission of any one of claims 14 to 23.

27. The method of claim 24 further comprising adjusting the amount of frictional engagement between two components of the transmission.

28. A transmission component, comprising:
a component having an engagement face; and
one or more formations wherein each formation is substantially elongate, the one or more formations running along the engagement face of the component, the one or more formations configured to be frictionally engagable with a substantially elongate recess of a second transmission component.

29. The transmission component of claim 28, wherein the component is circular and the one or more formations run substantially circumferentially around the component.

30. The transmission component of claim 28, wherein at least one of the one or more formations is substantially tooth-shaped in cross-sectional profile.

31. The transmission component of claim 28, wherein at least one formation of the one or more formations has two angled surfaces.

32. The transmission component of claim 31, wherein the angled surfaces of two adjacent formations form a recess, the recess configured to be frictionally engagable with a substantially elongate formation of a second transmission component.

33. The transmission component of claim 28, wherein the at least one of the one or more formations is substantially wedge-shaped.

34. The transmission component of claim 28 further comprising a plurality of formations and a plurality of recesses.

35. The transmission component of claim 28, wherein the one or more formations form a substantially zig-zag cross-sectional profile.

36. The transmission component of claim 28 which is configured to be rotatably mountable.

37. The transmission component of claim 28 which is configured to be a gear-like component of a transmission.

38. The transmission component of claim 28 which is configured to be a gear-like component of one of an epicyclic transmission and a strain wave transmission.

39. The transmission component of claim 38, wherein the epicyclic transmission is a compound epicyclic transmission.

40. The transmission component of claim 28 which is configured to be a sun gear-like component, or a planet gear-like component, or an annular gear-like component.

41. A transmission component, comprising:
a component having an engagement face;
one or more recesses wherein each recess is substantially elongate, the one or more recesses running along the engagement face of the component, the one or more recesses configured to be frictionally engagable with a substantially elongate formation of a second transmission component.

42. The transmission component of claim 41, wherein the component is circular and the one or more recesses run substantially circumferentially around the component.

43. The transmission component of claim 41, wherein each recess further comprises a first and second angled surface formed by two adjacent formations running along the engagement face of the component.

44. The transmission component of claim 43, wherein the at least one of the formations is substantially wedge-shaped.

45. The transmission component of any claim 41 further comprising a plurality of formations and a plurality of recesses wherein each recess is adjacent two formations.

46. The transmission component of claim 43, wherein the formations form a substantially zig-zag cross-sectional profile.

47. The transmission component of claim 41 which is configured to be rotatably mountable.

48. The transmission component of claim 41 which is configured to be a gear-like component of a transmission.

49. The transmission component of claim 41 which is configured to be a gear-like component of one of an epicyclic transmission and a strain wave transmission.

50. The transmission component of claim 49, wherein the epicyclic transmission is a compound epicyclic transmission.

51. The transmission component of claim 41 which is configured to be a sun gear-like component, or a planet gear-like component, or an annular gear-like component.

52. A transmission, comprising:
a first transmission component having have one or more elongate formations;
a second transmission component having one or more substantially elongate recesses; and
wherein the one or more formation of the first transmission component are frictionally engageable with the one or more recesses of the second transmission component, such that in use the first transmission component is capable of driving the second transmission component.

53. The transmission of claim 52, wherein the one or more recesses of the second transmission component are substantially complimentary of the one or more formations of the first transmission component.

54. The transmission of claim 52, wherein the one or more formations and the one or more recesses are shaped and dimensioned such that in use the transmission is substantially devoid of free play.

55. The transmission of claim 52 further comprising an adjustment mechanism configured to alter the position of the first transmission component relative to the second transmission component.

56. The transmission of claim 55, wherein the adjustment mechanism is configured to adjust the force exerted by the one or more formations of the first transmission component on the one or more recesses of the second transmission component.

57. The transmission of claim 55, wherein the adjustment mechanism comprises a ramped surface, the ramped surface being slidable relative to the transmission component to displace the first transmission component laterally.

58. The transmission of any claim 52, wherein the transmission is one of an epicyclic transmission and a strain wave transmission.

59. The transmission of claim 58, wherein the epicyclic transmission is a compound epicyclic transmission.

60. The transmission of claim 52, wherein the transmission is a speed reduction transmission.

61. The transmission of claim 52 that is operable is combination with a servo motor.

62. A method for improving the torque density of a transmission, the method comprising:
providing a first transmission component having one or more elongate formations and a second transmission component having one or more elongate recesses;
frictionally engaging the one or more formation of the first transmission component and the one or more recesses of the second transmission component; and
setting the amount of frictional engagement between two components of the transmission to improve the torque density of the transmission.

63. The method of claim 62 further comprising adjusting the amount of frictional engagement between two components of the transmission.
